(19) United States
(12) Patent Application Publication
(10) Pub. No.: US 2021/0166856 A1
(43) Pub. Date: Jun. 3, 2021

(54) THERMALLY INSULATED RADIATOR ELEMENT

(71) Applicant: SIEMENS AKTIENGESELLSCHAFT, MUENCHEN (DE)

(72) Inventor: FLORIAN BACHINGER, ST. GEORGEN/GUSEN (AT)

(21) Appl. No.: 16/772,939

(22) PCT Filed: Nov. 15, 2018
(86) PCT No.: PCT/EP2018/081311

§ 371 Date: Jun. 15, 2020

(30) Foreign Application Priority Data
Dec. 15, 2017 (DE) 10 2017 222 946.2

(51) Int. Cl. H01F 27/02; F28D 1/03; F28F 3/04; H01F 27/12

(52) U.S. Cl. CPC H01F 27/025; F28D 1/0325; F28F 2270/00; H01F 27/12; F28F 3/046

(57) ABSTRACT

An electrical device, such as a transformer or an inductor, for connecting to a high-voltage network includes a tank which is filled with an insulating fluid and which encases a magnetizable core and at least one winding. A cooling system includes at least one radiator which is arranged outside the tank and is connected to same for circulating the insulating fluid via the radiator. The radiator has at least two heat exchange elements connected in parallel with one another. In order to cost-effectively accelerate a cold start, one of the heat exchange elements is fitted with a thermal insulation unit which reduces the heat transfer from the insulating fluid into the insulated heat exchange element to the atmosphere in comparison with a heat exchange element with no thermal insulation unit.

The invention relates to an electrical device for connection to a high-voltage network, having a tank which is filled with an insulating fluid and in which a magnetizable core and at least one winding are arranged, and a cooling system, which comprises at least one radiator which is arranged outside the tank and is connected with the latter to circulate the insulating fluid via the radiator, wherein the radiator has at least two heat-exchange elements connected in parallel to one another.

Such a device is known in practice to a person skilled in the art. For example, transformers have a tank filled with insulating fluid, in which a magnetizable core is arranged. The core forms a limb, which is arranged concentrically to a low- and high-voltage winding enclosing it. The insulating fluid serves to insulate the windings, which are at high voltage potential during transformer operation, from the tank, which is at ground potential. Furthermore, the insulating fluid provides the necessary cooling of the windings. To this end, the insulating fluid heated by the windings is circulated via radiators mounted externally on the tank.

The viscosity of the insulating fluid is temperature-dependent and increases very significantly as temperatures fall. Due to the increase in viscosity at low external temperatures of below −10° C., circulation of the insulating fluid via the radiator(s) is impaired. This is problematic in particular after extended stoppage of the electrical device, since the insulating fluid has then completely cooled. The high viscosity needs to be taken into account with regard to the reduced cooling capacity of the cooling system when the electrical device is started from cold, since the windings may otherwise become overheated.

A transformer may thus for example be started in idling mode or under reduced load. If the electrical device has active cooling, pumps for circulating the insulating fluid via the radiator can only be connected in when the insulating fluid in the tank has exceeded a minimum temperature threshold value. This temperature threshold value is achieved in many cases however only after a few days.

Furthermore, alternative insulating fluids, such as ester and silicone oils are increasingly used in electrical devices of the above type. Although, as insulating fluids, ester oils exhibit better environmental compatibility, one drawback is that, at temperatures in the range below −10° C., they may exhibit such high viscosity that it becomes virtually impossible to start the electrical device from cold.

DE 317410 discloses an oil switch which has a tank filled with mineral oil. A current path which is heated during operation of the electrical device extends in the upper region of the tank. After a cold start in particular, the oil heated by the current path circulates solely in the upper region of the tank. In order also to recover the oil from the lower region for cooling, an external bridging pipe is provided on the tank, which is equipped with a heating element. It may moreover be pointed out that auxiliary apparatuses are known which consist of a pump and which set the insulating fluid in motion by means of cooling pipes mounted outside the tank.

The object of the invention is to provide an electrical device of the above-stated type with which a cold start may be inexpensively accelerated and also be carried out at low temperatures.

The invention achieves this object in that one of the heat-exchange element elements is equipped with a thermally insulating unit which reduces heat transfer from the insulating fluid in the insulated heat-exchange element to the external atmosphere in comparison with a heat-exchange element without a thermally insulating unit.

An electrical device is provided according to the invention which uses a thermally insulating unit to facilitate a cold start. The thermally insulating unit is arranged on at least one heat-exchange element and there reduces heat transfer from the insulating fluid, which is arranged in the insulated heat-exchange element, to the external atmosphere. The thermally insulating unit preferably reduces heat transfer by a factor of less than 1/10.

For the purposes of the invention, no appreciable dissipation of heat from the insulating fluid occurs within the insulated heat-exchange element and thus no renewed cooling of the insulating liquid which has just been heated. According to the invention, the thermally insulating unit therefore makes it possible for the insulating fluid, which is guided via the insulated heat-exchange element, not to cool down but rather to serve solely to accelerate cold starting of the electrical device. It has surprisingly been found that thermal insulation alone is sufficient for inexpensively accelerating cold starting of the electrical device. The invention therefore provides an effective means for accelerating cold starting or indeed for enabling it at all at particularly low temperatures.

Although the measure according to the invention reduces the cooling surface and thus increases the temperature level at normal ambient temperatures and in the case of normal operation, for example between −5° C. and +30° C., at low temperatures markedly improved flow of the insulating fluid through the thermally insulated heat-exchange element is enabled.

According to the invention, preferably just one heat-exchange element is equipped with a thermally insulating unit. In the case of just one heat-exchange element, the thermal insulation is generally sufficient, for the purposes of the invention, to achieve the desired cold start acceleration.

According to a preferred configuration, each radiator has an upper feed line and a lower return line which are each connected to the tank and, via the heat-exchange elements, to one another, wherein the heat-exchange element equipped with the thermally insulating unit is, as innermost heat-exchange element, at the smallest distance from the tank. For the purposes of the invention, the innermost heat-exchange element, which is thus at the smallest distance from the tank, is preferably equipped with the thermally insulating unit. In the event of a cold start, first of all the insulating fluid arranged directly on the core-and-coil assembly is heated, wherein the heat slowly spreads to the outer edge of the tank. The tank is connected to the radiator via the feed and return lines, wherein the heat-exchange element at the smallest distance from the tank is obviously heated up the fastest. Insulation of the innermost heat-exchange element therefore accelerates the cold start particularly well.

For the purposes of the invention, the way in which the insulating unit reduces heat transfer between insulating fluid and atmosphere at the heat-exchange element may in principle be selected at will. The thermally insulating unit is, however, preferably a thermally insulating layer which encloses the respectively associated heat-exchange element in places or completely. If the thermally insulating unit completely encloses the heat-exchange element, the heat-exchange element is completely enclosed by the thermally insulating unit or the thermally insulating layer or in other words is embedded therein. Heat can therefore only be dissipated from the insulating fluid to the external atmosphere via the outer thermally insulating unit. If the thermally insulating unit surrounds the heat-exchange element only in places, specific portions or points of the heat-exchange element are exposed. At these exposed points, air from the external atmosphere can therefore brush past the outer contour of the mostly metallic heat-exchange element and so convey away the heat. The thermally insulating layer is advantageously of flexible configuration and can be simply wound around the respective heat-exchange element.

The thermally insulating unit expediently consists of at least one thermally insulating material. It is of course also possible, for the purposes of the invention, for the thermally insulating unit to consist of a plurality of thermally insulating materials. What is essential is the reduction in heat transfer from the insulated heat-exchange element to the external atmosphere.

According to a preferred configuration of the invention, the thermally insulating unit has a heat transfer coefficient of less than

$$1 \frac{W}{{m}^{2} K} .$$

Such a heat transfer coefficient has proven sufficient to provide the necessary advantages for the purposes of the invention, i.e. an accelerated cold start.

It is still more expedient for the heat transfer coefficient to lie between 0.5 and

$$0.01 \frac{W}{{m}^{2} K} .$$

The cooling system is preferably a passive cooling system. In other words, this advantageous further development avoids pumps for circulating the insulating fluid via the cooling system. At variance therewith, a pump is provided for circulating the insulating fluid via the or each radiator.

The cooling system expediently has a plurality of radiators, wherein however just one radiator has a heat-exchange element equipped with a thermally insulating unit.

Further configurations and advantages of the invention constitute the subject matter of the following description of exemplary embodiments of the invention with reference to the figures of the drawings, wherein identically acting components are provided with identical reference signs and wherein

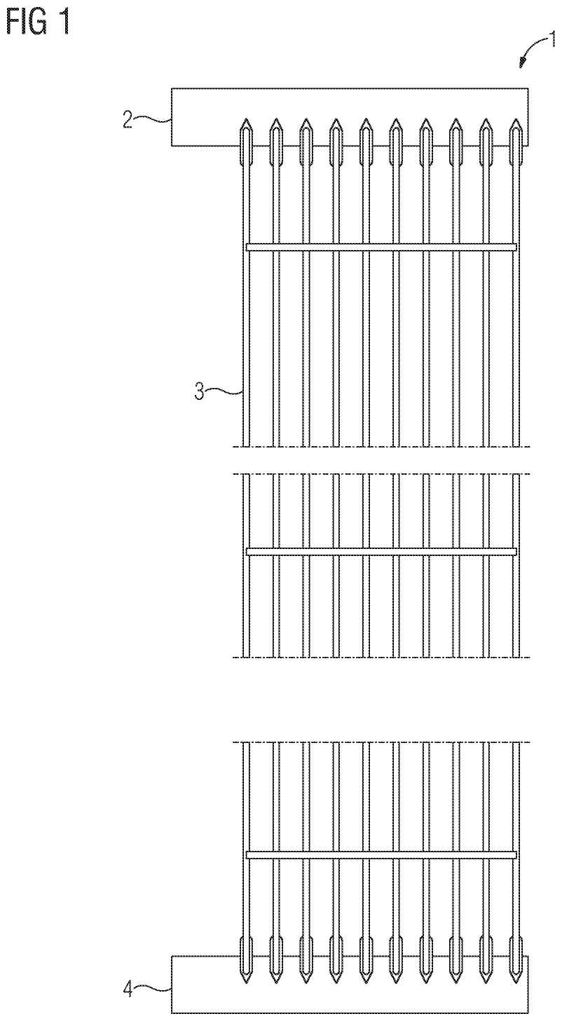

FIG. 1 is a side view of a conventional commercial radiator,

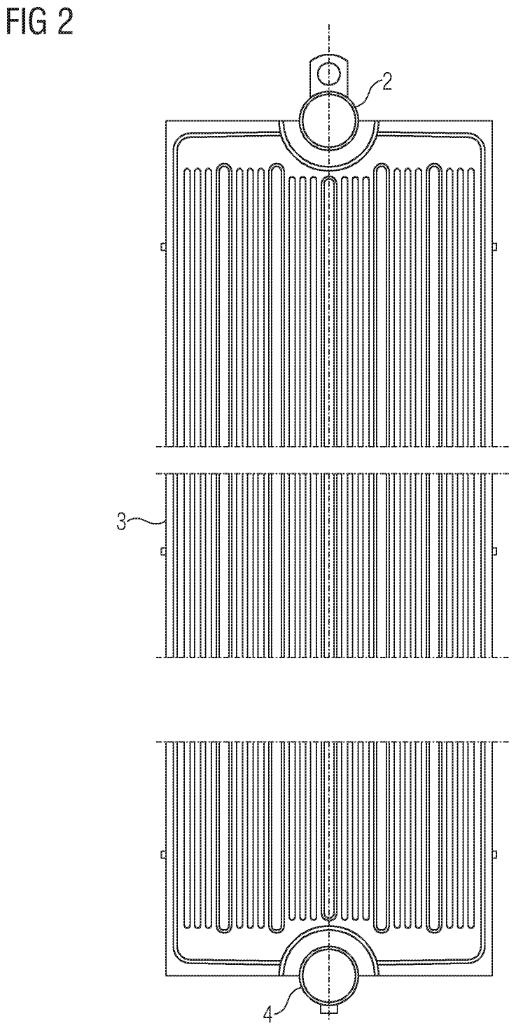

FIG. 2 is a plan view of a heat-exchange element of the radiator according to FIG. 1 and

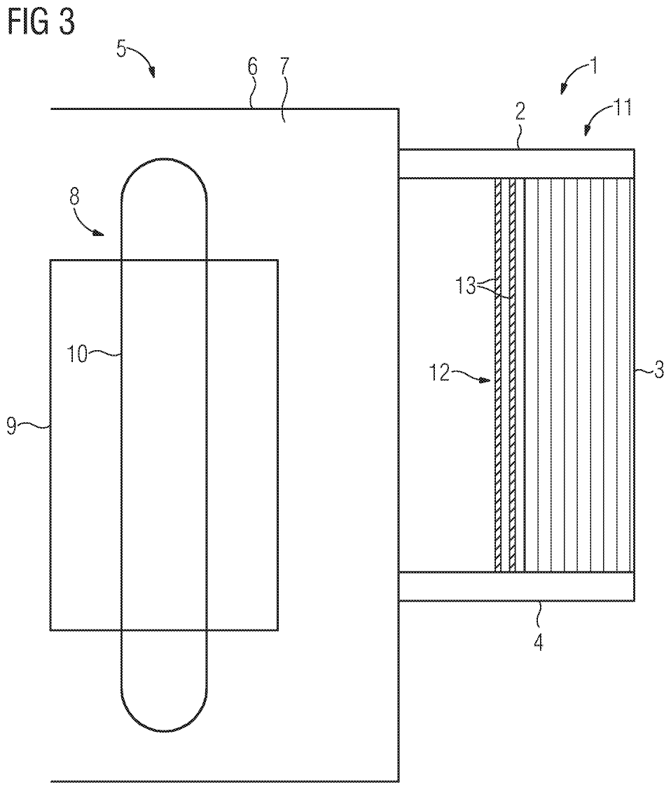

FIG. 3 is a schematic side view of an exemplary embodiment of the electrical device according to the invention.

FIG. 1 is a schematic side view of an exemplary embodiment of a conventional commercial radiator 1. It is apparent that the radiator 1 has an upper feed line 2 which is connected hydraulically with a return line 4 via heat-exchange element or radiator elements 3. The feed line 2 and the return line 4 have an inlet and outlet opening respectively which points to the left and via which the radiator 1 communicates after installation thereof with the interior of a tank not shown in FIG. 1. The insulating fluid of said tank may then be circulated via the feed line 2, the heat-exchange elements 3 and the return line 4 via the radiator 1 with its heat-exchange elements 3. The heat-exchange elements 3 are made of a thermally conductive material, such as a metal, and are in thermal contact with the external atmosphere. If the insulating fluid is guided via the heat-exchange elements, heat is thus dissipated from the heated insulating fluid to the colder external atmosphere.

FIG. 2 shows a heat-exchange element 3 in front view. It is apparent that the heat-exchange elements 3 are plate-shaped. In other words, the radiator 1 shown in FIG. 1 is a “plate radiator”. The plate-shaped heat-exchange elements 3 in each case define flow channels, through which the insulating fluid circulated via the heat-exchange elements 3 is guided. Ultimately, the insulating fluid arrives at the collecting return line 4 and thence arrives as cooled insulating fluid back in the interior of the tank.

FIG. 3 shows an exemplary embodiment of the electrical device 5 according to the invention, which here takes the form of a transformer. The electrical device 5 according to the invention may however also take the form of a choke. The transformer 5 has a tank 6, which is filled with an insulating fluid 7. Furthermore, a magnetizable core 8 and windings 9 are arranged in the tank 6, only one of these windings being indicated schematically in FIG. 3, however. The windings 9 here however comprise a “high-voltage winding” and a “low-voltage winding”, which are arranged concentrically to a limb 10 of the core 8. The mode of operation of such a transformer 5 is, however, known to a person skilled in the art and therefore will not be addressed in greater detail here. The necessary connection lines for connecting the windings to a high-voltage network are likewise not shown in the figures for reasons of clarity.

The transformer 5 is provided with a cooling system 11, here merely comprising a radiator 1 according to FIG. 1, attached to the outside of the tank 6. It is apparent that the feed line 2 and the return line 4 open into the interior of the tank 6. The fact that the feed line 2 and the return line 4 are connected together via heat-exchange elements 3 enables circulation of the insulating fluid 7 via the radiator 1. A heat-exchange element which is at the smallest distance from the tank 6, the “innermost radiator element” 12, is equipped with a thermally insulating unit 13. The thermally insulating unit 13 consists of an extensive thermally insulating layer 13, which encloses the entirety of the radiator element 12. The thermally insulating layer 13 is shown in sectional view in FIG. 3. A conventional adhesive bond serves to fasten the thermally insulating layer to the radiator element 12.

If the transformer 5 is at a standstill for a relatively long period, the insulating fluid 7 cools down completely. At low external temperatures in particular, for example in the range from −10° C. to −50° C., the insulating fluid 7 exhibits such a high viscosity, in other words it is so viscous, that it is no longer circulated via the radiator 1 even after an extended starting procedure. It is for this reason that the thermally insulating unit 13 is provided, which ensures that heated insulating fluid which has been only slightly heated is not immediately cooled again in the innermost heat-exchange element 12. For the purposes of the invention, the high-voltage winding of winding 9 may thus be connected to the high-voltage network. In contrast, a resistance appropriate therefor is applied to the low-voltage winding, such that the transformer 5 is not operated under full load. In this case, gradual heating of the insulating fluid 7 and thus of the outer wall of the tank 6 occurs. Cooling in the heat-exchange element 12 is greatly impeded, such that the circulated insulating fluid 7 is heated more rapidly. The continuous, gradually established heating of the insulating fluid 7 is transferred little by little also to the remaining heat-exchange elements 3, until the desired operating state is ultimately achieved.

It should finally be noted that, for the purposes of the invention, load control in the event of a cold start may be selected at will. At variance with the above-stated implementation of a cold start, the electrical device according to the invention may also be started under full load.

1-9. (canceled)

10. An electrical device for connection to a high-voltage network, the electrical device comprising:
a tank filled with an insulating fluid;
a magnetizable core and at least one winding disposed in said tank;
a cooling system having at least one radiator arranged outside and fluidically connected to said tank for circulating the insulating fluid via said radiator, said radiator having at least two heat-exchange elements connected in parallel with one another;
at least one of said heat-exchange elements being an insulated heat-exchange element equipped with a thermally insulating unit configured to reduce a heat transfer from the insulating fluid in said insulated heat-exchange element to an exterior atmosphere in comparison with a heat-exchange element without a thermally insulating unit.

11. The electrical device according to claim 10, wherein one single heat-exchange element is equipped with said thermally insulating unit.

12. The electrical device according to claim 11, wherein said at least one radiator has an upper feed line and a lower return line each connected to said tank and connected to one another via said heat-exchange elements, and wherein said insulated heat-exchange element that is equipped with said thermally insulating unit is an innermost heat-exchange element at a smallest distance from said tank.

13. The electrical device according to claim 10, wherein said thermally insulating unit encloses the respectively associated heat-exchange element in places or completely.

14. The electrical device according to claim 10, wherein said thermally insulating unit consists of at least one thermally insulating material.

15. The electrical device according to claim 10, wherein said thermally insulating unit has a heat transfer coefficient of less than
$$1 \frac{W}{{m}^{2} K} .$$

16. The electrical device according to claim 15, wherein the heat transfer coefficient lies between 0.5 and
$$0.01 \frac{W}{{m}^{2} K} .$$

17. The electrical device according to claim 10, wherein said cooling system is a passive cooling system.

18. The electrical device according to claim 10, wherein said cooling system has a plurality of radiators, and wherein only one of said radiators has a heat-exchange element equipped with said thermally insulating unit.
